(19) United States
(12) Patent Application Publication
(10) Pub. No.: US 2005/0189337 A1
(43) Pub. Date: Sep. 1, 2005

(54) Coated electrode with low fume emission and low hexavalent chromium for welding stainless steels

(75) Inventor: Emmanuel Baune, Champagne s/Oise (FR)

Correspondence Address: Linda K. Russell, Suite 1800, 2700 Post Oak Blvd., Houston, TX, 77056, US

(73) Assignee: L'Air Liquide, Societe Anonyme a Directoire et Conseil de surveillance pour l'Etude et l'Exploita

(21) Appl. No.: 11/068,105

(22) Filed: Feb. 28, 2005

(30) Foreign Application Priority Data
Mar. 1, 2004 (FR) 0450398

(51) Int. Cl. B23K 35/22

(52) U.S. Cl. 219/145.23

(57) ABSTRACT

A coated electrode for welding stainless steels. The electrode when used for welding, produces a low level of fumes, which in turn contains a low level of hexavalent chromium. The electrode has a central metallic core which is made of steel or stainless steel and which is covered with a covering that contains a lithium based compound. The covering does not contain any sodium or potassium based compounds like aluminosilicates. The covering also contains a lithium containing binder and metallic elements in the form of ferro-alloys or individual metallic elements.

The present invention relates to the field of environmentally friendly coated electrodes of the rutile type, with smooth melting, low fume emission and low emission of hexavalent chromium (Cr^{VI}) and having a strong coating, that is to say one that is not friable or only slightly friable, these being intended in particular for the welding of stainless steel.

The fume emitted during welding operations, arising from complex processes, namely vaporization/condensation/oxidation or vaporization/oxidation/condensation, counts among the detractions associated with arc welding. Consequently, the welding fume, the nature and the quantity of which constitute an increasing concern in manufacturing plants, necessitates the use of protection systems, such as fume extractors, so as to preserve the health of operators and members of the personnel working nearby.

From a general standpoint, a stainless steel is defined as an iron alloy whose nominal chromium content is at least 11% by weight. Its use is justified when good oxidation resistance and corrosion resistance are required. Among stainless steels there are several sub-categories of steel, namely:
austenitic steel, probably most widely used and often mentioned by the name “300 series” owing to its classification according to the United States standardization, the composition of which is based on the iron/chromium/nickel system and the total content of the elements Cr, Ni, Mn and Si in the alloy exceeds 16% by weight;
martensitic steel;
ferritic steel;
duplex steel;
precipitation-hardening steel alloys; and
steel superalloys.

Consequently, the high content of the element chromium in stainless steels means that, when they are being welded, the constituent particles of the welding fume contain a high content of compounds containing the element chromium, namely trivalent chromium (Cr^{III}), namely the least toxic form of the element chromium, and/or hexavalent chromium (Cr^{VI}), a form known as being highly toxic for humans since it is considered to be a carcinogen.

In the case of welding stainless steels, the hexavalent chromium element (Cr^{VI}), resulting from the welding fume and present in the air breathed, is therefore particularly regulated owing to its potential toxicity.

Thus, knowing that the regulations in force in most countries indicate that the tolerated average exposure value (AEV) is 5 mg/m³ of air for “harmless” fume particles and that that of the element Cr^{VI} contained in the fume is equal to 0.05 mg/m³, as reported by P. J. Cunat in “Le chrome dans les fumées de soudage des aciers inoxydables, [Chromium in stainless steel welding fume], Matériaux et Techniques, No. 1-2 2002, the maximum tolerated concentration of Cr^{VI}, in order for this not to entail the need for reducing the maximum fume content in the air breathed, must be at most 1%, i.e. (0.05/5)×100. Below 1%, Cr^{VI} is therefore not a factor limiting the amount of permissible fume in the air breathed.

In comparison, since the AEV of trivalent chromium (Cr^{III}) is 0.5 mg/m³, its maximum permissible concentration in fume, in order not to entail the need for reducing permissible fume in the air breathed, is 10%.

Beyond this figure, in welding shops, in order to limit the amount of fume and the proportion of CR^{VI} in the air breathed by operators below the maximum permissible values, using conventional welding products for stainless steels the ventilation of the welding shop must be very much better than that needed when using products for conventional steels.

By adjusting the formulation of a conventional coated electrode, it is possible to reduce the welding fume at source. These formulation modifications thus constitute the most effective way of limiting the harmful effects caused in the welder's environment, even before installing often expensive equipment, such as fume extractors.

This is all the more so as the method of welding with a coated electrode, owing to its ease of implementation, is widely used for welds in confined spaces in certain welding shops or worksites where it is sometimes difficult to install really effective fume extraction.

The principle of CR^{VI} generation in fume is illustrated by equations [1] and [2] below and lies in the formation, during welding, of certain noxious compounds containing the element Cr^{VI}, such as for example Na₂Cr^{VI}O₄, K₂Cr^{VI}O₄, NaK₃(Cr^{VI}O₄)₂ or K₂NaCr^{VI}F₆ resulting from the reaction of the elements sodium (Na) and potassium (K) present in the electrode composition with chromium (Cr):
2Na+Cr+2O₂→Na₂Cr^{VI}O₄ [1]
2K+Cr+2O₂→K₂Cr^{VI}O₄ [2]

To reduce the contents of these compounds containing the element Cr^{VI} in the fume, the document by S. Kimura, M. Kobayashi, T. Godai and S. Mimato, “Investigations on chromium in stainless steel welding fumes”, Welding Journal, pages 195s-203s, July 1979, proposed the elimination, in electrode coating formulations, of all ingredients containing the elements Na and K and substitution with “equivalent” ingredients based on lithium (Li).

Thus, it is known either to substitute Na or K feldspars, such as KAlSi₃O₈ or NaAlSi₃O₈, present in conventional non-environmentally friendly formulations for electrode coatings with Li-based aluminosilicate compounds having very similar properties, such as petalite LiAlSi₄O₁₀, spodumene LiAl(SiO₃)₂ or eucryptite LiAlSiO₄, or to replace the standard Na and K silicates with Li silicate.

However, this solution has always been difficult to implement and has never been really able to be established as an industrial practice since the use of a lithium-based binder as replacement for sodium- and/or potassium-based binders results in electrodes having a fragile, or even highly friable, coating, making the electrodes thus formulated unusable in an industrial environment where the electrodes are often accidentally knocked or roughly handled, leading to their rapid deterioration when they are not mechanically robust enough.

Moreover, compounds based on Na and K, whether in the form of powders and/or liquid silicates, are conventionally used almost automatically in the coatings of coated electrodes in order to give the products their good arc characteristics, especially arc stability and dynamics. This is the reason why electrodes formulated on the basis of lithium silicate alone, and therefore containing no Na and K, exhibit operating weldability that is very inferior to that of standard electrodes.

The document drawn from the experience of the Boehler Thyssen Welding group and published by V. E. Spiegel-Ciobanu “Entwicklung schadstoffarmer hoch legierter Cr—Ni-Schweisszusatze—Teil 1: Reduktion des Cr^{VI}-Gehalts im Schweissrauch [Development of low-pollutant welding filler wires for high Cr—Ni alloys—Part 1: reduction of the Cr^{VI} content in welding fume]”, Schweissen und Schneiden, 55(4), pages 198-200, May 2003 describes the difficulty of producing such environmentally friendly stainless steel electrodes containing no Na and K, in particular because of the low strength of their coating, and confirms their significantly inferior operating weldability compared with that of standard stainless steel products.

Finally, although the principle of substituting ingredients containing the elements Na and K with “equivalent” ingredients based on Li has been known for a long time for lowering the fume emission content and the amount of Cr^{VI} in the fume, only the document by T. Griffiths and A. C. Stevenson “Development of stainless steel welding electrodes having a low level of toxic chromium in the fume”, The 5th International Symposium of the Japan Welding Society, Advanced Technology in Welding, Materials Processing and Evaluation, 5JWS-IV-3, Tokyo, April 1990 describes the manufacture of stainless steel electrodes formulated from exclusively Li silicate and compounds and having a robust coating, with low fume and Cr^{VI} emissions, and having operating properties that are said to be “satisfactory”.

However, it turns out in practice that the operating properties of these electrodes have proved to be very inferior to those rutile-type electrodes said to be “smooth fusion” electrodes so that, since the publication of that document, no electrode of this type has appeared on the stainless steel electrode market.

Moreover, the documents by D. O'Donnell and R. Bishel, “Stable low fume stainless steel welding electrode”, Inco Alloys International Inc., 1991 and U.S. Pat. No. 5,124,530 and the document by Koike Hiroyuki, “Cr-contained coated electrode”, Nippon Steel Corp., 1989 and JP-A-1249297 themselves propose stainless steel electrodes with fume emission reduced simply by the use of mixed silicates based on Na, K and Li.

However, the use of mixed silicates based on Na, K and Li does not lower the Cr^{VI} content in the fume sufficiently, owing to the presence of Na and K elements resulting in the inevitable formation of hexavalent chromium according to the mechanisms of formulae (1) and (2) mentioned above.

Moreover, several other publications have dealt with fume emissions during welding, and mention may be made, by way of indication, of the following documents:
G. Carter, “The effects of basic electrode coating formulation on fume emission rate and in manual metal arc welding of steel”, Welding Institute Members Report 319, 1986;
J. Dennis, M. French, P. Hewitt, S. Mortazavi and A. Redding, ”Control and occupational exposure to hexavalent chromium and ozone in tubular wire arc welding processes by replacement of potassium by lithium or by addition of zinc”, Ann. Occup. Hyg., Vol. 46, No. 1, pp. 33-42, 2002;
T. Griffiths, “Development of stainless steel welding electrodes having a low level of toxic chromium in the fume”, Strasbourg seminar on welding fume: effects, control and protection, Paper 6, Abingdon, UK, The Welding Institute, 1991;
C. Bonnet, P. Rouault, B. Leduey, F. Richard and E. Bauné, “Amélioration de l'environment du soudeur par le biais de la formulation des consommables de soudage [Improvement in the welder's environment by formulation of welding consumables]”, Conference Proceedings of the 6th National Welding Workshop “Soudage et Prospective Industrielle [Welding and Industrial Prospectives]”, Tours, France, 21-25 October, 2002; and
E. Bauné, B. Leduey, F. Richard and P. Rouault, “Le soudage des aciers inoxydables à travers des exemples de l'évolution des consommables et des gaz [The welding of stainless steels with examples of developments in consumables and in gases]”, Proceedings of the CIMATS Colloque Industriel, Technical University of Belfort Montbéliard, 13 Dec. 2002.

Given the state of the art, the problem that arises is how to improve coated electrodes intended for welding stainless steels so as:
to be able to reduce the fume emission content by a factor of up to 2, or even beyond, in relation to standard conventional stainless steel electrodes;
to be able to obtain a Cr^{VI} content of less than 1% in the fume;
to have a robust and strong coating, that is to say one that is not friable; and
to be able to obtain a level of operating weldability in accordance with the requirements for electrodes of this type, especially as regards their arc, bead appearance and slag detachment characteristics.

In other words, the problem that arises is to provide a range of environmentally friendly coated electrode formulations, with a robust coating, of the smooth-fusion rutile type, intended for welding stainless steels, which result in a deposited metal (after fusion) whose chemical composition is in accordance with the standards relating to the various grades of stainless steel, in particular to the standards EN 1600 and AWS A5.4.

The solution of the invention is a coated electrode formed from a central metal core at least partly covered with a robust coating forming a covering over the said core, the said coating containing at least one lithium compound, preferably in general a feldspar, and being free of sodium feldspar and potassium feldspar, characterized in that the coating comprises (the percent by weight of each compound in question being expressed relative to the total weight of coating of the electrode):
5 to 45% by weight of at least one lithium-based aluminosilicate or 0.2 to 3% lithium coming from at least one lithium-based aluminosilicate;
at least one extrusion agent free of Na and/or K;
lithium silicate as binder;
about 10 to 55% by weight of one or more metal elements in the form of ferro-alloys or of individual elements; and
a total proportion of Na and K in the coating of between 0 and 0.50% by weight.

Within the context of the invention, the term “free of” a given compound is understood to mean that the said compound has not been intentionally included in the coating and, ideally, that the said coating does not contain any of it at all. However, the possible presence of this compound in trace form as unavoidable impurities is not excluded, although not desirable. Electrodes whose coating therefore contains such compound traces would be considered as being included within the field of protection provided by the present invention.

Depending on the case, the electrode of the invention may include one or more of the following technical features:
the total proportion of Na and K in the coating is less than 0.50%;
the central metal core is made of stainless steel or of mild steel;
the diameter of the core is between 1.6 and 6 mm, preferably between 2 and 4 mm;
the lithium compound(s) is (are) chosen from Li-based aluminosilicates. This (or these) typically has (have) a general chemical formula of the type LiAl (SiₓO_{y})
at least one lithium feldspar is chosen from spodumene, petalite and eucryptite. Preferably, the lithium-based coating constituents, such as spodumene LiAl(SiO₃)₂, petalite LiAlSi₄O₁₀ and eucryptite LiAlSiO₄, are present in the coating in a proportion of 5 to 45% by weight, preferably 12 to 40% by weight in the coating;
the lithium-containing binder is lithium silicate of typical formula (Li₂O)_{x.}(SiO₂)_{y.}(H₂O)_{z}. When preparing the coating, the lithium silicate is introduced in liquid form in a proportion of greater than 105 g/kg of dry formulation, preferably 120 to 220 g by weight of raw materials (only dry powders), more preferably 150 to 200 g, i.e., by weight of the following elements expressed relative to the total weight of coating of the electrode, more than 10% Si and more than 1.3% Li, preferably 11 to 21% Si and 1.5 to 2.9% Li and more preferably 14 to 19% Si and 1.9 to 2.6% Li;
at least one extrusion agent is chosen from the group formed by carboxymethylcellulose (CMC), hydroxyethylcellulose or any other water-soluble organic substance or resin, calcium alginate, plant-based polymers, such as guar gum, talc (with a typical formula of 3MgO.4SiO₂.H₂O), or else clay (with a typical formula of Al₂O_{3.}2SiO_{2.}2H₂O);
the coating comprises about 10 to 55% (if the core is made of steel) by weight of the coating of one or more metal elements in the form of ferro-alloys or of individual elements, the content of this or these metal elements being balanced in the coating according to the type of core used and the grade to be welded (308L, 309L, 316L, 347L, etc., using the nomenclature of the AWS standard);
the metal elements are chosen from manganese, nickel, chromium, molybdenum, iron, silicon, aluminium, niobium, titanium, tantalum and copper, and their blends or ferro-alloys comprising these elements;
it comprises 120 to 220 g of liquid lithium silicate/kg of dry formulation, i.e. 11 to 21% Si and 1.5 to 2.9% Li relative to the total weight of coating of the electrode;
the coating contains, expressed as a percent by weight in the coating, compounds used for making up the coating in the following proportions: 0.8 to 18.5% Al₂O₃, preferably, 2 to 16.5% Al₂O₃ (coming in particular from Li aluminosilicate(s) and possibly from other powders contained in the formulation), 5 to 40% SiO₂, preferably 9 to 35% SiO₂ (coming from Li silicate or silicates and coating powders, including Li aluminosilicates), 15 to 45% TiO₂, preferably 20 to 40% TiO₂, 2.8 to 8.5% CaO, preferably 4 to 7.5% CaO, 0.5 to 5% CaF₂, preferably 1 to 4% CaF₂, and 4 to 18% carbonates, in particular CaCO₃, preferably 8 to 13% carbonates;
the coating may also include at least one powder containing one or more of the elements chosen from S, Se, Te, Sb and Bi;
the coating may include, expressed as a percent by weight in the coating, 0.01 to 2%, preferably 0.03 to 1.3%, of one or more of the elements of the group S, Bi, Te, Se and Sb;
the coating may also contain, expressed as a percent by weight in the coating, other oxides and fluorides, in a proportion of 0.5 to 10%, preferably 3 to 7%;
the particle size distribution of the dry blend (excluding binder) has at least 20%, preferably 25 to 50%, of the particles with a size of greater than 100 μm, and at most 40%, preferably 5 to 30%, of particles with a size of less than 40 μm; and
the coating contains, expressed as a percent by weight in the coating, 4 to 18% of carbonates in powder form, in particular CaCO₃, preferably 8 to 13% of carbonates.

The invention also relates to a stainless steel arc welding process in which an electrode according to the invention is used to produce at least one welded joint on one or more workpieces to be welded, and to the coating of such an electrode. The operation of coated-electrode arc welding starts when the operator initiates the welding arc by touching/rubbing the tip of his electrode on the workpiece, the said electrode and the said workpiece forming an integral part of the electrical installation, in the same way as the welding generator, these being connected to one another via the combination of cables of the installation and the earth connection. The intense heat thus produced causes the tip of the electrode and the base metal to melt at the point of impact of the arc. Metal is then transferred through the arc to the workpiece. The metal is thus deposited on the workpiece progressively as the electrode is consumed by being melted. The operator must then ensure that the arc is maintained by keeping the tip of the electrode at a certain height above the workpiece and by moving it at a uniform speed along the workpiece. While the weld is being deposited, a sufficient quantity of heat is maintained in order to melt the tip of the electrode and the zone subjacent to the arc on the workpiece to be welded.

In general, a coated electrode for arc welding is an electrically conducting rod, called a core, surrounded by an adherent covering, usually called a coating, from the tip of which the welding arc emanates. The energy of the arc is thus used as a means of heating the workpieces to be joined together.

The invention also relates to a coating for an electrode, characterized in that it comprises, the percent (%) by weight of each compound being expressed relative to the total weight of coating of the electrode:
5 to 45% by weight of at least one lithium-based aluminosilicate or 0.2 to 3% lithium resulting from the combination of elements used for the formulation of the coating in the form of powders and binders, i.e. coming from at least one or more lithium compounds in the form of powder and of lithium silicate;
at least one extrusion agent free of Na and/or K;
lithium silicate as binder;
about 10 to 55% by weight of one or more metal elements in the form of ferro-alloys or of individual elements; and
a total proportion of Na and K in the coating of between 0 and 0.50% by weight.

During development of the coated electrode, the metal core is generally chosen, as far as possible, in such a way that its chemical composition corresponds to the grade of the base metal to be welded. However, it may also be made of mild steel, that is to say containing practically no alloying element with the exception of a small amount of manganese, the alloying elements essential for depositing the desired grade then being provided by the coating—this then being called a “synthetic” electrode. Whatever the case may be, the content of alloying elements of the coating is never zero, as this non-zero content makes it possible to improve the mechanical properties of the weld and to compensate for the losses due to volatilization of the metal elements during melting of the electrode when an alloyed core, whose composition is close to that of the metal to be deposited, is used, or to provide the alloying elements necessary for synthesizing the composition of the metal to be deposited when a mild steel core is used.

The coating has paramount influence on the welding characteristics and the resulting properties of the deposited metal. Its major roles are not only electrical and mechanical, but also metallurgical.

The main functions that the ingredients in the coating composition must provide are numerous. Most of the constituents may have more than one function and the combination of several constituents depending on the precise contents may allow a particular function to be achieved.

The various coating constituents may thus be classified in various families, namely the constituents in powder form and the constituents in liquid form.

The constituents in powder form are in particular:
agents for shielding the deposited metal, i.e. the shielding gas formers and the slag constituents. The shielding gas formers are mineral powders whose decomposition generates gas (CO₂, CO, HF, H₂, H₂O in vapour form, etc.) and shields the metal in transit in the welding arc from the ambient air. The slag constituents are mineral powders which are transformed to form the slag that envelops the metal drops in transit in the arc and that, on solidifying on the weld bead, shields it from the external atmosphere;
deoxidizing agents, which are mineral powders allowing purification of the weld by the formation and then settling of the oxides and sulphides formed;
arc initiators and stabilizers, which are mineral and metal materials that help in the initiation of the welding arc between the tip of the electrode and the workpiece to be welded and keep it stable;
alloying elements (also deoxidizing agents or reducing agents), which are metallic materials that help to alleviate the losses by volatilization in the arc of the constituent elements of the metal core and to enrich the weld bead with metal elements, or to synthesize the composition of the metal to be deposited when the electrode is formulated from a mild steel core;
agents for regulating the viscosity of the slag, which are metallic and mineral materials making it possible to control the melting range and the time that the slag takes to solidify on cooling. In particular, elements recognized as being powerful surfactants prove to be very effective;
agents for regulating the efficiency of the electrode, i.e. the ratio of the mass of deposited metal to the mass of molten core, these being metallic materials for adjusting the rate of deposition of the electrode; and
extrusion agents, which are organic materials making it possible, in combination with the binders and the powders used, to obtain good consistency of the paste and acquisition by the latter of its rheological properties for the purpose of extruding it. A good consistency of the paste often makes it possible to achieve good coating strength after baking.

Moreover, the constituents in liquid form are especially the binders, which most often are liquid silicates used for agglomerating the dry powders making up the coating before paste that allows extrusion to take place is formed.

The blend making up the coating composition for manufacture of a coated electrode is prepared in an operating method comprising the following steps.

The ingredients in dry form that have to make up the coating composition are firstly weighed and blended so as to obtain a uniform blend. A binder (or several binders) is(are) then added in order to wet the dry blend within a mixer.

After the rheological properties of the coating paste have been assessed, the latter is formed and then a concentric extrusion of the coating around the metal cores, precut to the required length, is carried out by means of an electrode press.

This therefore results in electrode concentricity or centring of the coating extruded around the cores. Good centring is necessary for the quality of the final product. The tips of the electrodes must then be prepared by brushing the coating. The initiating tip of the electrodes is usually prepared by graphitizing or aluminizing, depending on the nature of the product.

Finally, after the electrodes have been predried in the ambient atmosphere, they are baked in a furnace. This baking operation may be carried out, optionally in steps, up to a temperature of around 350-500° C.

The present invention will now be better understood thanks to the following detailed explanations and the appended figures.

Low Fume Emission and Low Cr^{VI} Content

In order to considerably reduce the contents of compounds containing the element Cr^{VI} in the fume, the formulation means employed consist in adopting the conventional solution of eliminating in the formulations all ingredients containing the alkaline metal elements Na and K and in substituting them with “equivalent” ingredients based on lithium (Li).

Thus, the Na-based and K-based compounds (KAlSi₃O₈ and NaAlSi₃O₈) normally present are replaced with equivalent or similar Li-based compounds, such as spodumene (LiAl(Si₂O₆)), petalite (LiAlSi₄O₁₀) or eucryptite (LiAlSiO₄) for example.

The main function of these compounds used as coating constituents is to control the viscosity of the liquid slag, help to form the slag and therefore to shield the deposited metal, and to help to stabilize the arc during welding.

Table 1 below illustrates, for two electrodes (A and B) of the 316L type, with a 2.5 mm diameter central core made of stainless steel of the 304L type, these being formulated on the same formulation basis and from the same lithium silicate introduced in liquid form in a fixed amount for wetting, the influence of the choice of feldspar type on the amount of hexavalent chromium in the welding fume generated by these electrodes.

The electrode of Formula A was formulated from a blend of dry powders according to the prior art, whereas the electrode of Formula B consisted of dry powders according to the invention, both formulations being manufactured by means of a lithium silicate according to the invention.

TABLE 1

| | | Formulation | |
|---|---|---|---|
| | | A | B |
| | | (according to | (according to |
| | | the prior art) | the invention) |
| Raw | Various metal | 20.1% | |
| materials | elements | | |
| (powders + | Oxides, | 50.8% | |
| binder) of | carbonates, | | |
| the coating | fluorides and | | |
| composition | other extrusion | | |
| (% by weight | agents | | |
| in the | Type of | Na and K | Spodumene |
| coating) | aluminosilicate | feldspar: | (=Li compound): |
| | | 24.9% | 24.9% |

| | | |
|---|---|---|
| Li | SiO₂ | 3.62% |
| silicate | Li₂O | 0.52% |
| (dry part) | Na₂O | 0.06% |

| Total: | 100% | |
|---|---|---|
| Resultant Cr^{VI} in the fume | 2.7% | 0.6% |
| Rate of fume emission | 0.13 g/min | 0.08 g/min |

As Table 1 shows, Formulation B according to the invention, formulated from spodumene as substitute for the Na and K feldspars used in Formulation A, results in a Cr^{VI} concentration in the fume of 0.6% instead of 2.7%, i.e. about 4 times lower.

Likewise, the rate of fume emission from Formulation B according to the invention is greatly reduced compared to that from Formulation A.

Moreover, within the context of the present invention, it was also necessary to consider extrusion agents for formulating the coated electrodes. In general, these are organic materials which, in combination with the binders and powders used, make it possible to obtain good consistency of the paste and acquisition by the latter of its rheological properties so that it can be extruded around the metal core of the electrode.

In addition, good paste consistency makes it possible to achieve good coating strength after baking. Moreover, the extrusion agents have to be chosen judiciously, since drying the electrodes results, within the coating, in them decomposing into ash, the hydroscopic nature of which is deleterious to the electrodes.

While taking all this into account, within the context of the present invention, certain constituent extrusion agents of conventional electrode coatings, which traditionally contain the elements Na or K, were replaced with other compounds containing neither of these elements. Thus, it is recommended within the context of the present invention to completely proscribe the extrusion agents frequently employed, such as Na or K alginates, and to replace them with suitable extrusion agents according to the invention, such as carboxymethylcellulose (CMC), hydroxyethylcellulose or any other water-soluble organic substance or resin, calcium alginate, plant-based polymers, such as guar gum, talc (with a typical formula of 3MgO.4SiO₂.H₂O) or else clay (with a typical formula of Al₂O₃.2SiO₂.2H₂O).

This is illustrated by the difference between the electrode C, which is in accordance with the invention except for the extrusion agents containing Na and K according to the prior art, and electrode D, which in all points is in accordance with the invention. Table 2 shows the effect of replacing the Na-based and K-based extrusion agents (in electrode of formulation C) with extrusion agents free of Na and K (in electrode of formulation D) on the amount of Cr^{VI} produced and the rate of fume emission, for electrodes of the smooth-fusion type and of the same diameter of 3.2 mm, manufactured from Li silicate (on the basis of 3.62% SiO₂+0.52% Li₂O+0.06% Na₂O dry form by weight in the coating) for the two stainless steel grades, 308L and 316L.

TABLE 2

| | Resulting Cr^{VI} in the | | Rate of fume emission | |
|---|---|---|---|---|
| | fume (%) | | (g/min) | |
| | C | D | C | D |
| | extrusion | extrusion | extrusion | extrusion |
| | agents | agents free | agents | agents free |
| | based on | of | based on | of |
| Formulation | Na and K | Na and K | Na and K | Na and K |
| 308L grade | 0.8 | 0.7 | 0.13 | 0.11 |
| 316L grade | 0.9 | 0.7 | 0.13 | 0.10 |

As may be seen, electrode D according to the invention results in about a 20% lower rate of fume emission than electrode C and a chromium^{VI} content reduced by more than 10% compared with electrode C.

Moreover, Table 3 specifies, for the combinations of extrusion agents used in formulations C and D of Table 2, the corresponding contents of elements Ca, Na and K.

TABLE 3

| | Extrusion agents of | Extrusion agents of |
|---|---|---|
| | Formulation C | Formulation D |
| Ca | 0.018% | 0.020% |
| Na | 0.072% | 0.006% |
| K | 0.041% | 0.005% |

The percentages (%) are expressed as % by weight in the constituent in question.

As may be seen in Table 3, the coated electrode D according to the invention contains approximately the same proportion of calcium as the electrode C, but contains, however, about 12 times less Na and 8 times less K.

The presence of the elements Na and K in the combination of extrusion agents used for formulation D comes from residual traces of these elements. Despite the precautions taken, formulation D is therefore not completely free of the elements Na and K, which are in these formulations in the form of impurities that are unavoidable but not intentionally desired.

Furthermore, to produce environmentally friendly stainless steel electrode formulations according to the invention, it is also essential to replace the Na-based and/or K-based binders normally used with purely Li-based binders.

The binders are generally aqueous silicates used in liquid form for agglomerating the dry powders making up the coating before the paste used for the extrusion is formed. The amount of silicate used must be such that a thin film is created between the powder particles, the silicate or silicates acting as a bridging agent between the powder particles.

Essentially all the water contained in these silicates is removed from the coating during the final baking of the electrodes, in order to leave in the coating only the dry part of the silicates introduced, that is to say the alkaline part composed of the compounds Na₂O, K₂O and Li₂O.

The optimum amount of binder to be used depends mainly on its viscosity, on the coupling established between binder and extrusion agents, and on the particle size distribution of the powders used in the formulation.

One of the constraints imposed on the manufacture of environmentally friendly stainless steel electrodes according to the invention is that lithium silicate has to be used instead of the conventional Na and/or K silicates.

Moreover, in order for the Cr^{VI} content in the fume to remain below the 1% objective set, the amount of lithium silicate must not exceed a certain maximum amount since above this permissible maximum amount the element Cr^{VI} again becomes the limiting factor in the welding fume.

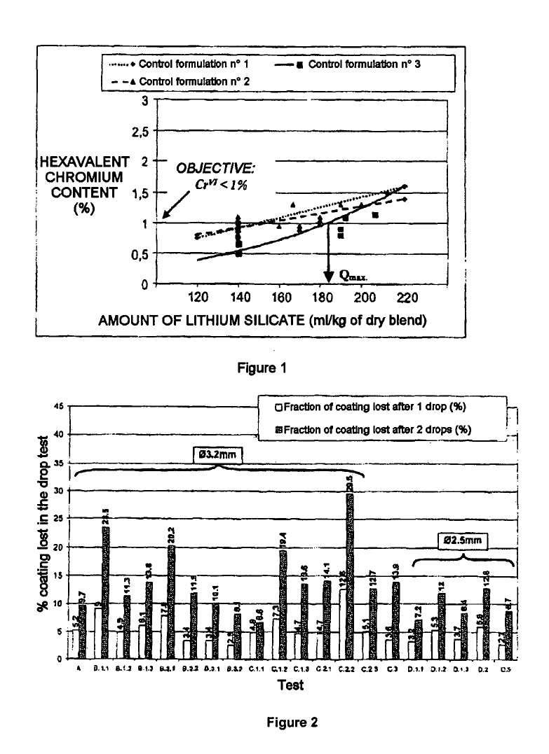

FIG. 1 shows the existence of such a maximum amount of lithium silicate (Qₘₐₓ) not to be exceeded for the various stainless steel formulation bases studied for the development of environmentally friendly stainless steel electrodes, while Table 4 below gives the coating compositions the control formulations 1 to 3 of FIG. 1. More precisely, the curves of FIG. 1 were established by making the formulation substitutions of the three examples described above, while varying the amount of Li silicate used. In the case of control formulation 3, the most promising one in terms of reduction in emitted fume and operating performance (smooth fusion, slag detachment, bead appearance) during the development, Qₘₐₓ was defined within the range from 170 to 200 ml of Li binder in liquid form per kg of dry blend, that is to say in dry form, within the range from 3.4 to 4% by weight in the coating in respect of SiO₂, from 0.4 to 0.6% in respect of Li₂O and from 0.05 to 0.06% in respect of Na₂O.

TABLE 4

| | | | Control |
|---|---|---|---|
| | Control | Control | formu- |
| | formulation | formulation | lation |
| | 1 | 2 | 3 |
| 304L grade metal core | 3.2 | 3.2 | 3.2 |
| diameter | | | |
| (in mm) | | | |
| Coating | 5.65 | 5.30 | 5.60 |
| diameter | | | |
| (in mm) | | | |

Raw materials (powders excluding binders) in the coating
composition (% by weight in the dry blend)

| | | | |
|---|---|---|---|
| Total metallic materials | 22.3 | 27.0 | 22.6 |
| (including total Cr) | (10.5) | (12.0) | (9.5) |
| Total extrusion agents | 0.8 | 1.8 | 2.2 |
| TiO₂ | 34.9 | 29.0 | 31.0 |
| CaCO₃ | 10.4 | 8.8 | 6.6 |
| CaF₂ | 3.9 | 3.2 | 2.8 |
| (K₂O)ₓ.(Na₂O)_{y}.(Al₂O₃)_{z}.(SiO₂)ₖ | 23.4 | 29.8 | 27.9 |
| (feldspar or Mica type) | | | |
| (Al, Mg, Ca, Na).Si₄O₁₀.(OH) | 4.1 | 0 | 0 |
| (clay or bentonite type) | | | |
| Fe₂O₃ | 0 | 0 | 1.7 |
| Various carbonates and | 0 | 0 | 4.7 |
| fluorides | | | |
| Various sulphates and | 0.3 | 0.4 | 0.4 |
| oxides | | | |
| Total | 100% | 100% | 100% |

Binders (amount introduced in liquid form in g/kg of dry blend)
Corresponding Na/K-based “conventional” binders:

| | | | |
|---|---|---|---|
| SiO₂ | 52 | 63 | 48 |
| Na₂O | 2.5 | 12 | 5 |
| K₂O | 22.5 | 19 | 17 |
| H₂O | 73-123 | 56-106 | 80-130 |

Corresponding Li-based “environmentally friendly” substitute
binders according to the invention:

| | |
|---|---|
| (Li₂O)ₓ.(SiO₂)_{y}.(H₂O)_{z} | 120-220 |
| H₂O | 0-80 |

That is:

| | |
|---|---|
| SiO₂ | 25-46 |
| Li₂O | 3.5-6.5 |
| Na₂O | 0.3-0.6 |
| H₂O | 80-180 |

Table 5 illustrates, for two 316L grade electrodes with a diameter of 2.5 mm, formulated on the same formulation basis and using spodumene, the influence of choice of silicate type, that is to say binder type, on the amount of Cr^{VI} in the welding fume and the rate of fume emission.

TABLE 5

| Formulation | |
|---|---|
| E | F |

| | | |
|---|---|---|
| Raw materials | Various | 21% |
| (powders | metallic | |
| excluding | elements | |
| binders) | Oxides, | 53% |
| in the coating | carbonates, | |
| composition (% | fluorides and | |
| by weight in | other extrusion | |
| the dry blend) | agents | |
| | Type of | Spodumene (Li-based compound): |
| | alumino- | 26% |
| | silicate | |

| | | |
|---|---|---|
| Silicate (in liquid form): | 180 g/kg of | 180 g/kg of |
| amount | Li silicate | Na/K silicate |
| type | | |
| Resulting Cr^{VI} in the fume | 0.6% | 3% |
| Rate of fume emission | 0.08 g/min | 0.14 g/min |

Formulation E according to the invention, formulated from Li silicate as a substitute for Na/K silicates in Formulation F according to the prior art gives a Cr^{VI} concentration in the fume of 0.6% instead of 3.0%, i.e. a reduction of 80%.

Likewise, the rate of fume emission from Formulation E is greatly reduced, being almost 50% of that of Formulation F.

Coating Robustness of the Coated Electrodes

The viscosity of the lithium silicates used within the context of the invention is generally very low, i.e. typically from 15 to 50 centipoise (cp) at room temperature (20° C.), and therefore much less than those of the conventional Na and/or K silicates, the viscosity range of which is typically from 150 to 600 cp. The density of the lithium silicate used within the context of the invention is around 1.2.

Consequently, owing to the high fluidity and the very specific rheological properties of the lithium silicate recommended within the context of the invention, substantial difficulties do arise at various stages in the process for manufacturing the environmentally friendly stainless steel electrodes, in particular:
the low viscosity of the Li silicate results in a lack of tack of the latter and, consequently, results in difficulties, on the one hand, in obtaining good plasticity of the paste used for its preparation during the mixing/wetting steps and, on the other hand, in compacting and extruding the paste and in forming it around the metallic core of the electrode;
the nature of the Li silicate causes an embrittlement effect in the coating, which occurs during the final electrode baking cycle.

Thus, without taking precaution in the formulation, the electrodes thus obtained have very fragile coatings and cannot thus claim to be sufficiently strong from the mechanical standpoint (resistance to impact, dropping, rubbing, bending, etc.) while they are being packaged, transported and subsequently used in an industrial environment.

To alleviate the abovementioned difficulties, it is necessary not only to judiciously choose the extrusion agents (e.g. CMC, guar gum, alginates), in particular their nature, amount and combination, which are compatible with the requirements necessary for formulating environmentally friendly electrodes according to the invention, but also to control the particle size distribution of the dry blend.

By complying with these formulation rules and using exclusively lithium silicate as binder, it is possible for environmentally friendly stainless steel electrodes of the smooth-fusion type, having a robust coating after they have been baked, to be manufactured on an industrial scale under satisfactory conditions.

In order to quantitatively assess the coating robustness of the electrodes manufactured in the course of the development, a drop test was carried out.

This test consists in successively dropping ten electrodes, obtained from the same manufacturing run, from a height of 1 m onto a hard horizontal surface, for example a concrete floor, and in expressing the robustness of their coatings with a fraction by weight of the coating lost after one fall, then after two falls.

The result expressed for each series corresponds to the mean calculated for the ten electrodes of the series in question.

FIG. 2 thus illustrates a series of results obtained from a number of electrode drop tests (electrodes having diameters of 2.5 mm and 3.2 mm) obtained from various manufacturing runs, for which the variations have been added to the formulation parameters mentioned above.

These results show that the parameters described have a considerable influence on the strength of the coating on the corresponding electrodes.

Moreover, by properly controlling the lithium silicate used, and also the formulation/manufacturing parameters, it is possible to achieve levels of coating robustness that are equivalent to those of standard, non-environmentally friendly, stainless steel electrodes, that is to say less than about 7% of the coating being lost after one drop in respect of electrodes having a core diameter of 3.2 mm or less, and less than about 15% in respect of electrodes whose core diameter is greater than 3.2 mm. It is also important to note that, during welding, no excessive or abnormal sign of embrittlement of the coating is observed when exposed to the heat of the arc that propagates along the electrode. Thus, the melting of the coating during welding meets the requirements for such smooth-fusion electrodes.

Another test aimed at assessing the coating strength of the said electrodes, consisting in bending them around a compressed-gas cylinder having a diameter of 230 mm, was used to confirm the good robustness of the coating on the environmentally friendly electrodes formulated from lithium silicate according to the present invention.

Moreover, another series of tests consisted in manufacturing a number of prototype electrodes of the 316L type, by varying the particle size distribution of the dry blend, while also varying the type of rutile (TiO₂) and calcite (CaCO₃) powders used, these being the predominant non-metallic powders in the formulation of the coating for the smooth-fusion environmentally friendly electrodes.

Crossed tests were carried out by using feldspars and Na/K-based silicates for manufacturing conventional stainless steel electrodes, and spodumene and Li silicate free of Na/K, these being necessary in order to manufacture the environmentally friendly stainless steel electrodes of the invention.

For these tests Na/K-free extrusion agents were used.

The particle size distribution of these powders is given in Table 6.

TABLE 6

| | Powder of the coating formulation and corresponding particle size | | | | | | |
|---|---|---|---|---|---|---|---|
| | distribution (fraction in % by weight in the various powders) | | | | | | |
| | | | | | | | Combination |
| | | | | | | | of metallic |
| | | | | | | | powders plus |
| | | | | | | | other oxides, |
| Screen | “Fine” | “Coarse” | “fine” | “Coarse” | Na/K | | carbonates |
| (μm) | rutile | rutile | calcite | calcite | feldspar | Spodumene | and fluorides |
| 315 | 0 | 0 | 0 | 2 | 0 | 0 | 2 |
| 250 | 0 | 0 | 0 | 12 | 0 | 0 | 7 |
| 200 | 0 | 0 | 0 | 10 | 0 | 0 | 4 |
| 160 | 0 | 3 | 0 | 16 | 0 | 0 | 9 |
| 125 | 0 | 43 | 0 | 24 | 3 | 0 | 24 |
| 100 | 0 | 40 | 0 | 20 | 4 | 0 | 12 |
| 80 | 0 | 14 | 0 | 0 | 19 | 3 | 17 |
| 63 | 0 | 0 | 2 | 0 | 12 | 16 | 12 |
| 50 | 0 | 0 | 2 | 15 | 5 | 10 | 5 |
| 40 | 1 | 0 | 1 | 0 | 2 | 4 | 3 |
| <or | 99 | 0 | 95 | 1 | 55 | 67 | 5 |
| =40 | | | | | | | |

(fractions in % by weight used on screens, obtained by screening the powder in question in order of decreasing size of screen)

The data given in Tables 7a and 7b show the importance of having a good distribution of the dry blend for obtaining electrodes with a robust coating, each table providing a matrix of tests for demonstrating the influence of the nature of the coating powders and the silicate used on the coating robustness of the electrodes and their environmental friendliness.

TABLE 7a

| Formulation | | | | | | | |
|---|---|---|---|---|---|---|---|
| 1 | 2 | 3 | 4 | 5 | 6 | 7 | 8 |

Raw materials (powders excluding binders) in the coating
composition (% by weight in the dry blend):

| | | | | | | | | |
|---|---|---|---|---|---|---|---|---|
| Combination of | 25 | 25 | 25 | 25 | 25 | 25 | 25 | 25 |
| metallic | | | | | | | | |
| powders (Ni, | | | | | | | | |
| Cr, Mo etc.) + | | | | | | | | |
| other oxides, | | | | | | | | |
| carbonates and | | | | | | | | |
| fluorides | | | | | | | | |
| Na/K feldspar | 26 | 26 | 26 | 26 | 0 | 0 | 0 | 0 |
| Spodumene | 0 | 0 | 0 | 0 | 26 | 26 | 26 | 26 |
| “Fine” rutile | 37 | 37 | 0 | 0 | 37 | 37 | 0 | 0 |
| “Coarse” rutile | 0 | 0 | 37 | 37 | 0 | 0 | 37 | 37 |
| “Coarse” | 9 | 0 | 9 | 0 | 9 | 0 | 9 | 0 |
| calcite | | | | | | | | |
| “Fine” calcite | 0 | 9 | 0 | 9 | 0 | 9 | 0 | 9 |

| | |
|---|---|
| Na/K silicate | 180 |
| in liquid form | |
| (g/kg of dry | |
| blend) | |
| Li silicate in | 0 |
| liquid form | |
| (g/kg of dry | |
| blend) | |

Resulting characteristics of the electrodes:

| | | | | | | | | |
|---|---|---|---|---|---|---|---|---|
| Coating | 5.6 | 8.7 | 9.9 | 8.0 | 2.3 | 1.2 | 7.9 | 7.1 |
| robustness (1) | | | | | | | | |
| Conforming/ | yes | x | x | x | yes | yes | x | x |
| non- | | | | | | | | |
| confirming (2) | | | | | | | | |
| Environmental | x | x | x | x | x | x | x | x |
| friendliness | | | | | | | | |
| (3) | | | | | | | | |

(1): loss by weight in the drop test as a % in accordance with the test described with regard to the results of FIG. 2;
(2): for assessing the robustness of the electrode coatings, “x” means that the coating is too friable to allow the electrode to be packaged, transported and used under industrial conditions; “yes” means that the coating robustness of the manufactured electrodes conforms to the requirements and allows them to be packaged, transported and used satisfactorily;
(3): “x” means not conforming and “yes” means conforming to the requirements.

TABLE 7b

| Formulation | | | | | | | |
|---|---|---|---|---|---|---|---|
| 9 | 10 | 11 | 12 | 13 | 14 | 15 | 16 |

Raw materials (powders excluding binders) in the coating
composition (% by weight in the dry blend):

| | | | | | | | | |
|---|---|---|---|---|---|---|---|---|
| Combination of | 25 | 25 | 25 | 25 | 25 | 25 | 25 | 25 |
| metallic | | | | | | | | |
| powders (Ni, | | | | | | | | |
| Cr, Mo etc.) + | | | | | | | | |
| other oxides, | | | | | | | | |
| carbonates and | | | | | | | | |
| fluorides | | | | | | | | |
| Na/K feldspar | 26 | 26 | 26 | 26 | 0 | 0 | 0 | 0 |
| Spodumene | 0 | 0 | 0 | 0 | 26 | 26 | 26 | 26 |
| “Fine” rutile | 37 | 37 | 0 | 0 | 37 | 37 | 0 | 0 |
| “Coarse” rutile | 0 | 0 | 37 | 37 | 0 | 0 | 37 | 37 |
| “Coarse” | 9 | 0 | 9 | 0 | 9 | 0 | 9 | 0 |
| calcite | | | | | | | | |
| “Fine” calcite | 0 | 9 | 0 | 9 | 0 | 9 | 0 | 9 |

| | |
|---|---|
| Na/K silicate | 0 |
| in liquid form | |
| (g/kg of dry | |
| blend) | |
| Li silicate in | 180 |
| liquid form | |
| (g/kg of dry | |
| blend) | |

Resulting characteristics of the electrodes:

| | | | | | | | | |
|---|---|---|---|---|---|---|---|---|
| Coating | 11.4 | 13.3 | 12.4 | 12.7 | 7.4 | 8.2 | 5.6 | 4.4 |
| robustness (1) | | | | | | | | |
| Conforming/ | x | x | x | x | x | x | yes | yes |
| non- | | | | | | | | |
| confirming (2) | | | | | | | | |
| Environmental | x | x | x | x | yes | yes | yes | yes |
| friendliness | | | | | | | | |
| (3) | | | | | | | | |

(1): loss by weight in the drop test as a % in accordance with the test described with regard to the results of FIG. 2;
(2): for assessing the robustness of the electrode coatings, “x” means that the coating is too friable to allow the electrode to be packaged, transported and used under industrial conditions; “yes” means that the coating robustness of the manufactured electrodes conforms to the requirements and allows them to be packaged, transported and used satisfactorily;
(3): “x” means not conforming and “yes” means conforming to the requirements.

These Tables 7a and 7b show that the simultaneous/combined use of the “environmentally friendly” ingredients, namely Li silicate, spodumene and Na/K-free extrusion agents, makes the task even more tricky if it is desired to manufacture environmentally friendly stainless steel electrodes with a strong coating.

To formulate stainless steel products of the smooth-fusion and low fume emission type requires the use of a number of powders having a specific nature depending on the precise contents.

Obtaining stainless steel electrodes of the strong, environmentally friendly, smooth-fusion type is therefore determined by the use of a particle size distribution not limited to only small screen sizes, when Li-based ingredients are used exclusively.

This may be obtained by the use of a rutile powder, a compound in a predominant amount in the coating flux, the particle size distribution of which lies predominantly above 100 μm.

In general, this is obtained by the combined use of a major portion of the blend, the mean particle size of which is greater than or equal to 100 μm, with a secondary portion of fine powders, that is to say of size <40 μm.

Operating Performance of Coated Electrodes, in Particular Smooth Fusion and Slag Detachment

Fusion reflects the manner in which the electrode melts during welding. It characterizes the transfer of molten coating and metal droplets that takes place between the electrode, which is consumed, and the weld pool on the workpiece to be welded.

Fusion that takes place with the transfer of predominantly fine droplets is termed “smooth fusion”. It is characterized in this case by a regular noise, of low sound intensity, on which a slight crackling is superposed, and is a sign of obvious operating comfort for the welder.

Smooth fusion is accompanied by a very low amount of spatter during welding. These spatter particles, when they exist, are very fine and represent the amounts of metal that are ejected from the arc during welding or that result from the splashing of the liquid metal droplets in the weld pool.

In flat welding, the slag line is the line that defines the boundary between the weld pool, that is to say the liquid metal, at the tip of the electrode and the liquid slag floating on the surface.

Since it defines the size of the weld pool, the shape and the stability of the slag line determines the shape and the regularity of the subjacent weld bead and, in particular, the fineness and the regularity of the striations on the surface of the weld bead after solidification.

For a “smooth fusion” electrode, the slag line is generally very close to the tip of the electrode behind the base of the arc.

The formulation of a smooth-fusion electrode must therefore be such that the slage line appears calm and stable, as otherwise it may constitute an impediment for the welder and generate surface defects in the bead (relatively pronounced and irregularly spaced striations, etc.) or even inclusions of slag in the deposit.

In general, the formulation of a smooth-fusion electrode must allow stable fusion and a stable slag line to be obtained.

Apart from the operating aspect during welding, a smooth-fusion stainless steel electrode is characterized by:
in horizontal fillet welding, a generally flat, or even concave, bead appearance;
fine striations regularly spaced apart;
a stable and regular weld bead;
of course, a bead free of defects, such as channels, slag adhesion, cracks or pitting; and
easy slag detachment, or even self-detachable slag, over its entire length or over certain parts.

In the smooth-fusion rutile formulations, surfactant elements, such as Sb, Bi, Se, Te and S, must be judiciously controlled in the coatings in order to obtain good slag detachment without affecting the operating performance and/or the strength of the product's coating.

Tables 8a and 8b show that obtaining an environmentally friendly stainless steel electrode according to the invention, of the smooth-fusion type and with a robust coating, is dependent on the use of a number of raw materials whose proportions must be judiciously controlled.

More precisely, Tables 8a and 8b indicate test matrices for demonstrating the influence of the nature of the coating powders used on the operating performance of electrodes and the robustness of their coating.

TABLE 8a

| | | Formulation | | | | | | | |
|---|---|---|---|---|---|---|---|---|---|
| | | 1 | 2 | 3 | 4 | 5 | 6 | 7 | 8 |
| | Rutile | 35.4 | 35.4 | 35.4 | 35.4 | 35.4 | 35.4 | 35.4 | 35.4 |
| Raw | Various | 9.6 | 9.6 | 9.6 | 9.6 | 1.9 | 1.9 | 1.9 | 1.9 |
| materials | carbonates | | | | | | | | |
| (powders + | S coming | 0.7 | 0.7 | 0 | 0 | 0.7 | 0.7 | 0 | 0 |
| binders) | from | | | | | | | | |
| in the | various | | | | | | | | |
| coating | sulphates | | | | | | | | |
| composi- | Total | 0.4 | 0 | 0.4 | 0 | 0.4 | 0 | 0.4 | 0 |
| tion | amount of | | | | | | | | |
| (in % by | Sb, Bi, Se | | | | | | | | |
| weight in | and Te | | | | | | | | |
| the | Li | 4.2 | 4.2 | 4.2 | 4.2 | 4.2 | 4.2 | 4.2 | 4.2 |
| coating) | silicate | | | | | | | | |
| | (dry part, | | | | | | | | |
| | i.e. SiO₂ + | | | | | | | | |
| | Li₂O + | | | | | | | | |
| | traces, | | | | | | | | |
| | inc. Na₂O) | | | | | | | | |

Characteristics resulting from the electrodes:

| | | | | | | | | |
|---|---|---|---|---|---|---|---|---|
| Smooth fusion with | yes | yes | yes | yes | yes | yes | yes | yes |
| little spatter | | | | | | | | |
| Stable fusion/slag | x | yes | yes | yes | x | x | x | x |
| line | | | | | | | | |
| Slag detachment | yes | yes | yes | x | yes | yes | yes | x |
| Bead appearance | x | yes | yes | yes | x | x | x | x |
| Coating robustness | x | x | yes | yes | x | x | yes | yes |

“x” means not conforming and “yes” means conforming to the requirements.

TABLE 8b

| | | Formulation | | | | | | | |
|---|---|---|---|---|---|---|---|---|---|
| | | 9 | 10 | 11 | 12 | 13 | 14 | 15 | 16 |
| | Rutile | 14.3 | 14.3 | 14.3 | 14.3 | 14.3 | 14.3 | 14.3 | 14.3 |
| Raw | Various | 9.6 | 9.6 | 9.6 | 9.6 | 1.9 | 1.9 | 1.9 | 1.9 |
| materials | carbonates | | | | | | | | |
| (powders + | S coming | 0.7 | 0.7 | 0 | 0 | 0.7 | 0.7 | 0 | 0 |
| binders) | from | | | | | | | | |
| in the | various | | | | | | | | |
| coating | sulphates | | | | | | | | |
| composi- | Total | 0.4 | 0 | 0.4 | 0 | 0.4 | 0 | 0.4 | 0 |
| tion | amount of | | | | | | | | |
| (in % by | Sb, Bi, Se | | | | | | | | |
| weight in | and Te | | | | | | | | |
| the | Li | 4.2 | 4.2 | 4.2 | 4.2 | 4.2 | 4.2 | 4.2 | 4.2 |
| coating) | silicate | | | | | | | | |
| | (dry part, | | | | | | | | |
| | i.e. SiO₂ + | | | | | | | | |
| | Li₂O + | | | | | | | | |
| | traces, | | | | | | | | |
| | inc. Na₂O | | | | | | | | |

Characteristics resulting from the electrodes:

| | | | | | | | | |
|---|---|---|---|---|---|---|---|---|
| Smooth fusion with | x | x | x | x | x | x | x | x |
| little spatter | | | | | | | | |
| Stable fusion/slag | x | yes | yes | yes | x | x | x | x |
| line | | | | | | | | |
| Slag detachment | yes | yes | yes | x | yes | yes | yes | x |
| Bead appearance | x | x | x | yes | x | x | x | yes |
| Coating robustness | x | x | yes | yes | x | x | yes | yes |

“x” means not conforming and “yes” means conforming to the requirements.

Characteristics of the Final Product

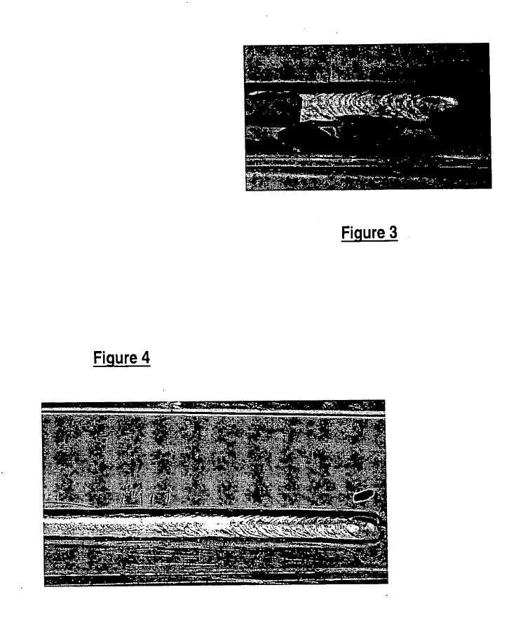

Table 9 below summarizes all the fundamental principles involved in the formulation/manufacture of environmentally friendly stainless steel electrodes according to the invention that must be met in order to optimize their main properties, namely reduced fume emission, low hexavalent chromium content, less than 1% in the fume, possible manufacture, robust coating, good operating weldability (i.e. smooth fusion, stable arc, little or no spatter), and a weld bead that is attractive, sound, clean, uniform, shiny and finely striated, with good wetting, as shown in the photographs in FIGS. 3 and 4, and good slag detachment, as shown in FIG. 3.

TABLE 9

| | Main electrode properties | | | | | |
|---|---|---|---|---|---|---|
| Necessary | | | | | | Easy |
| conditions for | | | | Good | Good | slag |
| formulating the electrode | Low rate | Low Cr^{VI} | Electrode | electrode | operating | cleaning |
| so as to obtain good | of fume | level in | manufacture | coating | performance | and |
| electrode properties | emission | the fume | possible | strength | (*) | removal |
| Use of lithium silicate | X | X | | | | |
| Use of a maximum | X | X | | | | |
| permissible amount of | | | | | | |
| lithium silicate | | | | | | |
| Use of particular | X | X | X | X | | |
| extrusion agents | | | | | | |
| Use of chosen | | | X | X | | |
| combinations of | | | | | | |
| particular extrusion | | | | | | |
| agents | | | | | | |
| Particle size | | | X | X | X | X |
| distribution | | | | | | |
| Absence of Na and K by | X | X | | | | |
| replacing (feldspar) | | | | | | |
| powders with similar Li- | | | | | | |
| based powders (spodumene, | | | | | | |
| petalite, etc.) | | | | | | |
| Use of appropriate | | | X | | X | X |
| surfactant elements and | | | | | | |
| combinations | | | | | | |

(*): i.e. smooth fusion, stable arc, little or no spatter and a weld bead that is attractive, sound, clean, uniform, shiny and finely striated, with good wetting.

Table 10 below shows the unique character of the environmentally friendly stainless steel electrodes of the invention manufactured using lithium silicate and Li-based substitution powders compared with non-environmentally friendly “conventional” stainless steel electrodes formulated from Na and/or K silicates and other ingredients containing the elements Na and K.

The environmentally friendly stainless steel electrodes of the invention make it possible to reduce the fume emission by between 25% and 98% compared with standard stainless steel electrodes and result in a Cr^{VI} content (expressed as a % in the fume) 4 to 5 times lower than those of standard electrodes.

Only the environmentally friendly electrodes of the invention give a low hexavalent chromium content, which in addition is less than 1%, which means that Cr^{VI} is no longer the factor that determines the toxicity of the fume, and consequently the amount of Cr^{VI} emitted (expressed in g/min) is from 5 to 9 times less than those from standard stainless steel electrodes.

TABLE 10

| | | | Rate of Cr^{VI} |
|---|---|---|---|
| | Rate of fume | Cr^{VI} content in | emission in |
| | emission | the welding | the welding |
| | (g/min) | fume (%) | fume (g/min) |
| “Conventional” non- | 0.15 to 0.19 | 2.2 to 3.2 | 0.30 to 0.60 |
| environmentally friendly | | | |
| electrodes formulated | | | |
| from Na and K | | | |
| Environmentally friendly | 0.10 to 0.11 | 0.5 to 0.6 | 0.05 to 0.07 |
| electrodes formulated | | | |
| from Li | | | |

The values indicated above correspond to electrodes formulated on a 3.2 mm diameter core made of 316L grade.

Comparison of the compositions of the fume emitted by these various electrodes illustrates the difference in their formulations (see Table 11).

TABLE 11

| | Fume composition (in % by weight relative to | | |
|---|---|---|---|
| | the total weight of the fume collected) | | |
| | K | Na | Li |
| “Conventional” non- | 24 to 38% | 1 to 7% | 0.1 to 0.4% |
| environmentally friendly | | | |
| electrodes formulated | | | |
| from Na and K | | | |
| Environmentally friendly | 1 to 1.5% | 1 to 1.5% | 4 to 6% |
| electrodes formulated | | | |
| from Li | | | |

The values indicated above correspond to electrodes of 316L grade with diameters of 2.5 and 3.2 mm.

1-16. (canceled)

17. An apparatus which may be used as a coated electrode, said apparatus comprising:
a) a central metal core; and
b) a coating which covers at least part of said metal core, wherein:
1) said coating is free of both sodium feldspar and potassium feldspar; and
2) said coating comprises:
aa) a first component, wherein based upon a weight percentage relative to the total weight of said coating, said first component comprises at least one member selected from the group consisting of:
i) about 5% to about 45% of at least one lithium-based aluminosilicate; and
ii) about 0.2% to about 3% lithium from at least one lithium-based aluminosilicate;
bb) at least one extrusion agent free of an element, wherein said element comprises at least one member selected from the group consisting of:
i) sodium; and
ii) potassium;
cc) lithium silicate;
dd) a first amount of at least one metal component, wherein based upon the total weight of said coating, said first amount is between about 10% and about 55%; and
ee) a second amount of a second component; wherein
i) based upon the total weight of said coating, said second amount is between about 0% and about 1%; and
ii) said second component comprises:
aaa) sodium; and
bbb) potassium.

18. The apparatus of claim 17, wherein said metal component comprises at least one member selected from the group consisting of:
a) ferro-alloys; and
b) individual metallic elements.

19. The apparatus of claim 17, wherein said core is made of either stainless steel or a mild steel.

20. The apparatus of claim 17, wherein the diameter of said core is between about 1.6 mm and about 6 mm.

21. The apparatus of claim 20, wherein said diameter is between about 2.5 mm and 4 mm.

22. The apparatus of claim 17, wherein said aluminosilicate comprises at least one member selected from the group consisting of:
a) spodumene;
b) petalite; and
c) eucryptite.

23. The apparatus of claim 22, wherein:
a) said coating further comprises at least one lithium feldspar;
b) said lithium feldspar comprises at least one member selected from the group consisting of:
1) spodumene;
2) petalite; and
3) eucryptite.

24. The apparatus of claim 17, wherein based upon a weight percentage relative to the total weight of said coating, said apparatus comprises:
a) greater than about 10% silicon; and
b) greater than about 1.3% lithium.

25. The apparatus of claim 24, wherein based upon a weight percentage relative to the total weight of said coating, said apparatus comprises:
a) about 11% to about 21% silicon; and
b) about 1.5% to about 2.9% lithium.

26. The apparatus of claim 17, wherein based upon a weight percentage relative to the total weight of said coating, the amount of said second component is less than about 0.50%.

27. The apparatus of claim 17, wherein said extrusion agent comprises at least one member selected from the group consisting of:
a) carboxymethylcellulose (CMC);
b) hydroxyethylcellulose;
c) water-soluble organic substances;
d) water-soluble resins;
e) calcium alginate;
f) plant-based polymers;
g) guar gum;
h) talc; and
i) clay.

28. The apparatus of claim 18, wherein:
a) based upon a weight percentage relative to the total weight of said coating, the amount of said metal component is about 20%; and
b) said metallic component comprises at least one member selected from the group consisting of:
1) manganese;
2) nickel;
3) chromium;
4) molybdenum;
5) iron;
6) silicon;
7) aluminum;
8) niobium;
9) tantalum;
10) copper; and
11) alloys thereof.

29. The apparatus of claim 28, wherein based upon a weight percentage relative to the total weight of said coating, said apparatus comprises:
a) about 11% to about 21% silicon; and
b) about 1.5% to about 2.9% lithium.

30. The apparatus of claim 17, wherein based upon a weight percentage relative to the total weight of said coating, said coating comprises:
a) about 0.8% to about 18.5% Al₂O₃;
b) about 5% to about 40% SiO₂;
c) about 15% to about 45% TiO₂;
d) about 2.8% to about 8.5% CaO; and
e) about 0.5% to about 5% CaF₂.

31. The apparatus of claim 30, wherein based upon a weight percentage relative to the total weight of said coating, said coating comprises:
a) about 2% to about 16.5% Al₂O₃;
b) about 9% to about 35% SiO₂;
c) about 20% to about 40% TiO₂;
d) about 4% to about 7.5% CaO; and
e) about 1% to about 4% CaF₂.

32. The apparatus of claim 17, wherein based upon a weight percentage relative to the total weight of said coating, said coating comprises:
a) about 0.4% to about 10.0% aluminum;
b) about 2.0% to about 19.0% silicon;
c) about 9.0% to about 27.0% titanium;
d) about 0.2% to about 3.0% calcium; and
e) about 0.2% to about 3.0% lithium.

33. The apparatus of claim 32, wherein based upon a weight percentage relative to the total weight of said coating, said coating comprises:
a) about 1% to about 9% aluminum;
b) about 4% to about 17% silicon;
c) about 12% to about 24.0% titanium;
d) about 0.5% to about 2.5% calcium; and
e) about 0.4% to about 2.6% lithium.

34. The apparatus of claim 17, wherein:
a) said coating is made from a dry blend of coating powers; and
b) said blend comprises:
1) at least about 17%, by weight, of particles with a size greater than about 100 μm; and
2) at least about 8%, by weight, of particles with a size less than about 40 μm.

35. The apparatus of claim 17, wherein:
a) the amount of material detaching from said coating after a drop test, in which said apparatus is dropped from a height of about 1 meter onto a hard horizontal surface, is less than about 15% by weight relative to the total weight of said coating; and
b) the diameter of said core is between about 1.6 mm and about 6 mm.

36. The apparatus of claim 35, wherein:
a) the amount of material detaching form said coating after said drop test is less than about 7% by weight relative to the total weight of said coating; and
b) the diameter of said core is less than about 3.2 mm.

37. The apparatus of claim 17, wherein based upon a weight percentage relative to the total weight of said coating, said coating comprises about 4% to about 18% carbonates in a power form.

38. The apparatus of claim 37, wherein based upon a weight percentage relative to the total weight of said coating, said coating comprises about 8% to about 13% said carbonates.

39. The apparatus of claim 38, wherein said carbonates comprise CaCO₃.

40. A method which may be used for arc welding at least one stainless steel work piece, comprising producing a weld on a workpiece with an electrode, wherein said electrode comprises:
a) a central metal core; and
b) a coating which covers at least part of said metal core, wherein:
1) said coating is free of both sodium feldspar and potassium feldspar; and
2) said coating comprises:
aa) a first component, wherein based upon a weight percentage relative to the total weight of said coating, said first component comprises at least one member selected from the group consisting of:
i) about 5% to about 45% of at least one lithium-based aluminosilicate; and
ii) about 0.2% to about 3% lithium from at least one lithium-based aluminosilicate;
bb) at least one extrusion agent free of an element, wherein said element comprises at least one member selected from the group consisting of:
i) sodium; and
ii) potassium;
cc) lithium silicate;
dd) a first amount of at least one metal component, wherein based upon the total weight of said coating, said first amount is between about 10% and about 55%; and
ee) a second amount of a second component, wherein:
i) based upon the total weight of said coating, said second amount is between about 0% and about 1%; and
ii) said second component comprises:
aaa) sodium; and
bbb) potassium.

41. A composition comprising:
a) a first component, wherein said first component comprises at least one member selected from the group consisting of:
1) about 5% to about 45%, by weight, of at least one lithium-based aluminosilicate; and
2) about 0.2% to about 3% lithium;
b) at least one extrusion agent free of an element, wherein said element comprises at least one member selected from the group consisting of:
1) sodium; and
2) potassium;
c) lithium silicate;
d) a first amount of at least one metal component, wherein:
1) said first amount is, by weight, between about 10% and about 55% of the total weight; and
2) said first component comprises at least one member selected from the group consisting of:
i) ferro-alloys; and
ii) individual metallic elements; and
e) a second amount of a second component, wherein:
1) said second amount is, by weight, between about 0% and about 1% of the total weight; and
2) said second component comprises:
i) sodium; and
ii) potassium.
